(19) United States
(12) Patent Application Publication
(10) Pub. No.: US 2010/0258760 A1
(43) Pub. Date: Oct. 14, 2010

(54) THERMAL STORAGE DEVICE AND USE OF MULTICOMPONENT SYSTEMS

(75) Inventors: Thomas Bauer, Stuttgart (DE); Rainer Tamme, Stuttgart (DE)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Deutsches Zentrum fuer Luft- und Raumfahrt e.V.

(21) Appl. No.: 12/764,483

(22) Filed: Apr. 21, 2010

Related U.S. Application Data
(63) Continuation of application No. PCT/EP2008/063447, filed on Oct. 8, 2008.

(30) Foreign Application Priority Data
Oct. 22, 2007 (DE) 10 2007 052 235.7

(51) Int. Cl. C09K 5/06

(52) U.S. Cl. 252/71

(57) ABSTRACT

A thermal storage device is provided which comprises at least one storage medium which is a multicomponent mixture having a melting range between the solid phase of the mixture and the liquid phase of the mixture extending over at least 10 K.

### CROSS-REFERENCE TO RELATED APPLICATIONS

This application is a continuation of international application number PCT/EP2008/063447, filed on Oct. 8, 2008, which claims priority to German application number 10 2007 052 235.7, filed Oct. 22, 2007, which are both incorporated herein by reference in their entirety and for all purposes.

### FIELD OF THE INVENTION

The invention relates to a thermal storage device.

### BACKGROUND OF THE INVENTION

From DE 30 38 844 A1, it is known to use a ternary salt mixture for heat transfer and/or as a heat store in which a ternary salt mixture of calcium nitrate (which may contain water of crystallization), potassium nitrate, and sodium nitrate is used.

From US 2004/0118449 A1, there is known a solar power system capable of storing heat energy.

### SUMMARY OF THE INVENTION

In accordance with the present invention, there is provided a thermal storage device which has a high energy density with respect to the thermal storage.

In accordance with an embodiment of the invention, the thermal storage device comprises at least one storage medium which is a multicomponent mixture having a melting range between the solid phase of the mixture and the liquid phase of the mixture extending over at least 10 K.

A corresponding multicomponent mixture is in a melting phase between the solidus and the liquidus. Both sensible heat and heat of fusion can be stored within the corresponding melting range. There is a solid-liquid phase change within the correspondingly large melting range (with a temperature width of at least 10 K).

The melting range is adjustable by the composition of the components in the multicomponent system.

The storage medium has an increased effective thermal capacity within the melting range. An increased energy density for the storage of heat is thereby obtained, as compared to pure sensible heat storage.

Further, in the storage device with a component system (the multicomponent system), relatively large temperature ranges can be covered, which may be, for example, on the order of 50 K to 100 K.

The solution in accordance with the invention provides a melting range store which is adaptable to an application in a simple way by varying the composition of the multicomponent system.

It is particularly advantageous if the melting range extends over at least 30 K and preferably extends over at least 50 K. A high temperature spread with a correspondingly large temperature use range is thereby obtained. Further, a high effective energy density for the thermal storage is obtained.

It is, in particular, provided that a transition temperature from the solid phase to the melting range is above 100° C. and in particular above 120° C. A melting range store can thereby be implemented which has a high thermal density.

In particular, the multicomponent mixture is a mixture of two or three miscible components. It is also possible to use more than three miscible components. Thereby, at least one partial store can be provided with only one storage medium system in a simple way.

It has been proven to be advantageous for the components of the multicomponent mixture to be salts, and in particular alkaline salts and/or alkaline earth salts. The temperature width of the melting range can thereby be adjusted in a simple way by adjusting the composition of the mixture. Further, the initial temperature and the final temperature of the melting range can be adjusted by a corresponding selection of the salt system. Furthermore, such metal salts usually have good miscibility.

In particular, the components of the multicomponent mixture are nitrates and/or nitrites and/or sulfates and/or carbonates and/or chlorides and/or hydroxides and/or bromides and/or fluorides and/or thiocyanates. In principle, any desired combination of these components is possible.

It can be provided that the at least one storage medium is embedded in a matrix. Component mixtures with melting ranges often tend toward phase separation. Phase separation can be avoided by embedding such a storage medium in an additional matrix.

In particular, a matrix material of the matrix is then in the solid phase in the relevant temperature range in order to enable an embedding in the relevant temperature range.

In an alternative embodiment, a mixing device for mixing the components of the multicomponent mixture is provided. Phase separation can thereby be counteracted by providing for a mixture by means of the mixing device.

The mixing device is configured, for example, as a pumping device and/or stirring device in order to counteract phase separation.

It can be provided that there are several partial stores, each having a storage medium with a different melting range with respect to solidification temperature and/or liquefaction temperature and/or temperature width of the melting range. A range of use can thereby be implemented that covers a high temperature range of, for example, several 100 K.

In accordance with the invention, a multicomponent system with a melting range of a temperature width of at least 10 K between solidification temperature and liquefaction temperature is used as a thermal storage medium.

The following description of preferred embodiments serves, in conjunction with the drawings, to explain the invention in further detail.

### BRIEF DESCRIPTION OF THE DRAWINGS

FIG. 1 is a schematic representation of a thermal storage device;

FIG. 2 is the phase diagram of the two-component mixture of KNO₃—NaNO₃;

FIG. 3 is an enthalpy-temperature diagram of the KNO₃(90 wt %)-NaNO₃(10%) two-component mixture:

FIG. 4 shows heat flow versus temperature for a two-component mixture with different compositions;

FIG. 5 shows heat flow versus temperature for a three-component mixture with different compositions; and

FIG. 6 is a schematic representation of a cascaded thermal storage device.

### DETAILED DESCRIPTION OF THE INVENTION

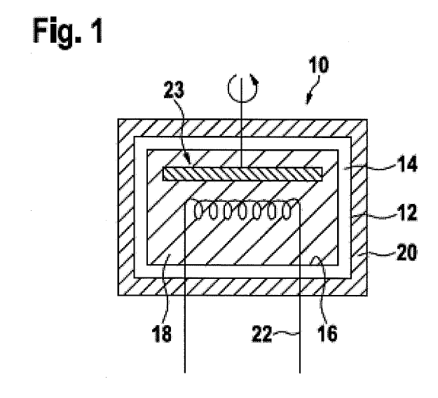

An embodiment of a thermal storage device, which is schematically shown in FIG. 1 and denoted there by 10, comprises a container 12 having a wall 14. Formed within the wall 14 are one or more chambers 16 which receive a storage medium 18.

The container 12 has a thermal inner insulation and/or outer insulation 20.

Associated with the container 12 is a throughflow device 22 through which a working medium can flow through the chamber 16 such that it can release heat to the storage medium 18 (in a charging cycle) or pick up heat (in a discharging cycle).

The thermal storage device comprises a mixing device 23, which serves for thorough mixing of the storage medium 18 in the chamber 16. The mixing device 23 is, for example, configured as a pumping device which permanently or at least temporarily recirculates the storage medium in order to provide for thorough mixing. It can also be configured as a stirring device comprising one or more—for example rotatable—stirrers in order to provide for thorough mixing.

In accordance with the invention, it is provided that the storage medium 18 is a multicomponent mixture having a melting range with a temperature width of at least 10 K.

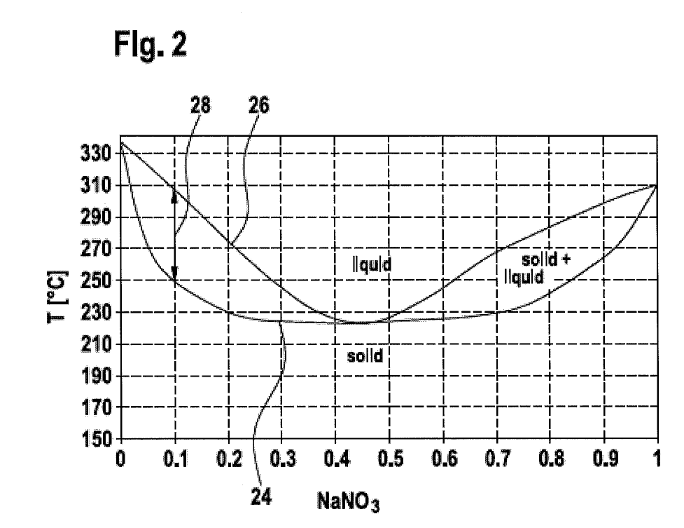

As an example thereof, the phase diagram of the KNO₃—NaNO₃ two-component mixture (plotted as a function of the weight fraction of NaNO₃) is shown in FIG. 2. The mixture comprises the two miscible components KNO₃ and NaNO₃.

Below a solidification temperature 24, which is mixture-dependent, the mixture is in the solid phase (solidus). Above a liquefaction temperature 26, which is also dependent on the composition of the mixture, the mixture is in the liquid phase (liquidus).

With certain mixture compositions, this two-component mixture has a melting range 28 which extends over a temperature of 10 K or more.

In the melting range shown in FIG. 2, in which the two-component mixture is composed of 10 wt % of NaNO₃ and 90 wt % of KNO₃, the melting range extends from 250° C. to approx. 300° C.

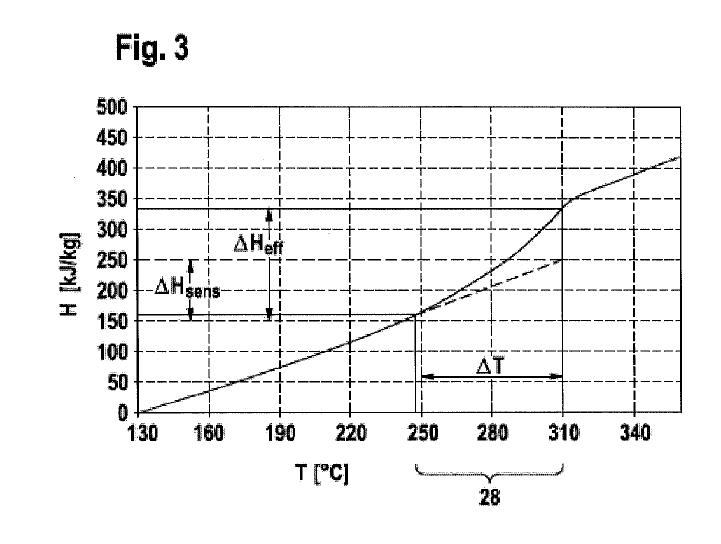

FIG. 3 shows the enthalpy-temperature diagram relating to this two-component mixture. The corresponding values were obtained from DSC (Differential Scanning Calorimeter) measurements.

The width of the melting range 28 is the temperature spread ΔT in which the storage device 10 is operable. This temperature width ΔT is selectable by adjustment of the melting range 28 via a corresponding mixture composition.

In the melting range 28, the two-component mixture exhibits a higher effective thermal capacity compared to a sensible storage medium. The sensible stored heat ΔH is calculated from the thermal capacity cₚ at a temperature change from temperature T₁ to temperature T₂ of a material of mass m, as

$$Δ H = m \cdot {\int }_{{T}_{1}}^{{T}_{2}} {c}_{p} d T$$

In the liquidus, ΔH is essentially proportional to the temperature. This is also true in the solidus case. In the melting range 28, as shown in FIG. 3, an increased effective stored heat ΔH_{eff} is obtained. The ratio of ΔH_{eff}, as an index, to ΔHₛₑₙₛ, as sensible stored heat, can be influenced by selection of the mixture.

In the solution in accordance with the invention, a multicomponent system with a non-eutectic mixture is used. The temperature width of the melting range 28 is greater than 10 K and preferably greater than 30 K and more preferably greater than 50 K. The solidification temperature 24 (maximum temperature in the solidus) is preferably above 100° C. and particularly above 130° C.

In principle, multicomponent mixtures with melting ranges 28 tend toward phase separation. It can, therefore, be provided that the storage medium is embedded in an additional matrix of a material which is solid in the relevant temperature range. A composite system with the matrix material and the embedded storage medium is thereby obtained.

Alternatively, phase separation can be counteracted by means of the mixing device 23 by providing, in particular mechanically, for a thorough mixing of the components of the multicomponent mixture and thus counteracting phase separation.

In the multicomponent system, two components or three components or even more than three components which are miscible can be used. Possible components are alkaline salts and/or alkaline earth salts. In particular, nitrates, nitrites, sulfates, carbonates, chlorides, hydroxides, bromides, fluorides, or thiocyanates are used.

Possible combinations of components are binary and ternary salt systems, such as nitrate-nitrate salt systems, nitrate-nitrite salt systems, carbonate-carbonate salt systems, nitrate-carbonate salt systems, nitrate-sulfate salt systems or sulfate-sulfate salt systems.

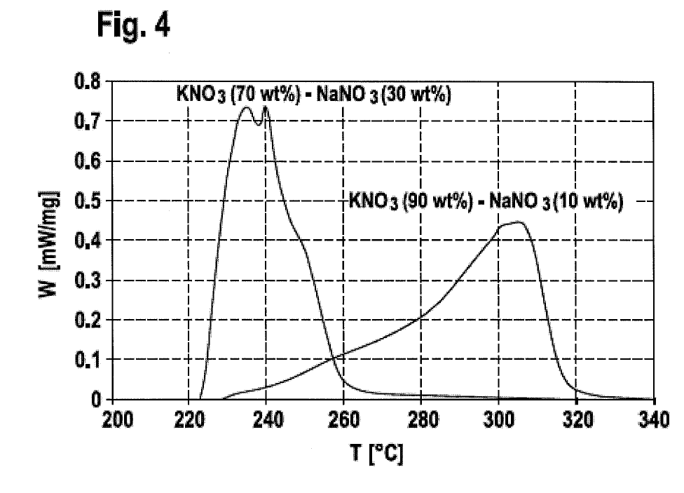

FIG. 4 is a diagram of heat flow versus temperature for the KNO₃—NaNO₃ system with two different compositions. Heat flow was determined by DSC measurements. Measurements were conducted at an initial sample weight of approx. 20 mg and a heating rate of 10 K/min. The eutectic has a melting temperature of 223° C., and the melting point of NaNO₃ is 310° C., and the melting point for KNO₃ is 336° C.

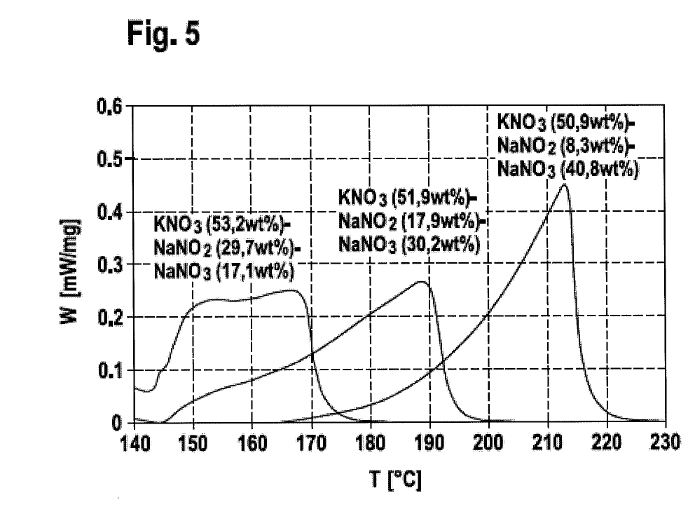

FIG. 5 shows the heat flow for the KNO₃—NaNO₂—NaNO₃ system with three different compositions. DSC measurements were conducted at an initial sample weight of approx. 20 mg and a heating rate of 5 K/min. The eutectic has a melting temperature of approx. 142° C.

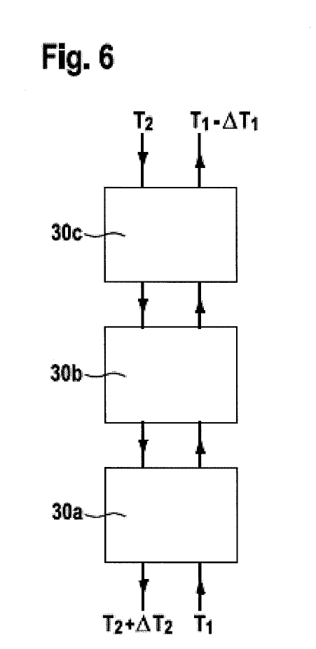

It is possible for the storage device to comprise several partial stores 30a, 30b, 30c (FIG. 6). Each of these receives a storage medium which is a multicomponent mixture with a melting range. Different partial stores receive different storage media. Temperature ranges for the storage device can thereby be covered which may span several 100 K; by a corresponding selection of the storage medium in different partial stores, a cascading of melting ranges with respect to solidification temperature and/or liquefaction temperature and/or temperature width of the melting range can be achieved.

A thermal storage device 10 in accordance with the invention can be used for storing thermal energy, for example in building services engineering, process engineering, and power plant engineering.

1. Thermal storage device comprising:
at least one storage medium which is a multicomponent mixture having a melting range between the solid phase of the mixture and the liquid phase of the mixture extending over at least 10 K.

2. Thermal storage device in accordance with claim 1, wherein the melting range extends over at least 30 K.

3. Thermal storage device in accordance with claim 1, wherein the melting range extends over at least 50 K.

4. Thermal storage device in accordance with claim 1, wherein a transition temperature from the solid phase to the melting range is above 120° C.

5. Thermal storage device in accordance with claim 1, wherein the multicomponent mixture is a mixture of two or three miscible components.

6. Thermal storage device in accordance with claim 1, wherein the components of the multicomponent mixture are salts.

7. Thermal storage device in accordance with claim 6, wherein the components of the multicomponent mixture are at least one of alkaline salts and alkaline earth salts.

8. Thermal storage device in accordance with claim 1, wherein the components of the multicomponent mixture are at least one of nitrates, nitrites, sulfates, carbonates, chlorides, hydroxides, bromides, fluorides, and thiocyanates.

9. Thermal storage device in accordance with claim 1, wherein the at least one storage medium is embedded in a matrix.

10. Thermal storage device in accordance with claim 9, wherein a matrix material of the matrix is in the solid phase in the relevant temperature range.

11. Thermal storage device in accordance with claim 1, which comprises a mixing device for mixing the components of the multicomponent mixture.

12. Thermal storage device in accordance with claim 11, wherein the mixing device is configured as at least one of a pumping device and stirring device.

13. Thermal storage device in accordance with claim 1, comprising a plurality of partial stores, each having a storage medium with a different melting range with respect to at least one of a solidification temperature, liquefaction temperature, and temperature width of the melting range.
